(19) United States
(12) Patent Application Publication
(10) Pub. No.: US 2010/0117034 A1
(43) Pub. Date: May 13, 2010

(54) Organic semiconductor material using CNTs increased, organic semiconductor thin film using the same and organic semiconductor device employing the thin film

(75) Inventors: Kook Min Han, Suwon-si (KR); Jae Young Choi, Suwon-si (KR); Seon Mi Yoon, Yongin-si (KR); Sang Yoon Lee, Seoul (KR); Jong Min Kim, Suwon-si (KR); Byung Ki Kim, Gunpo-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/512,178

(22) Filed: Aug. 30, 2006

(30) Foreign Application Priority Data
Feb. 3, 2006 (KR) 2006-0010628

(51) Int. Cl. H01B 1/12; H01B 1/04

(52) U.S. Cl. 252/510; 977/750; 977/752; 977/936

(57) ABSTRACT

Example embodiments of the present invention relate to an organic semiconductor material using carbon nanotubes having increased semiconductivity, an organic semiconductor thin film using the same and an organic semiconductor device employing the thin film. By using the organic semiconductor material according to example embodiments of the present invention, a room-temperature wet process may be applied and a high-performance organic semiconductor device capable of simultaneously exhibiting increased electrical properties is provided.

### PRIORITY STATEMENT

This non-provisional application claims the benefit of priority under 35 U.S.C. §119 from Korean Patent Application No. 2006-010628, filed on Feb. 3, 2006 in the Korean Intellectual Property Office, the entire contents of which are herein incorporated by reference in their entirety.

### BACKGROUND OF THE INVENTION

1. Field of the Invention

Example embodiments of the present invention relate to an organic semiconductor material using carbon nanotubes (CNTs) having increased semiconductivity, an organic semiconductor thin film using the same and an organic semiconductor device employing the thin film. Other example embodiments of the present invention relate to an organic semiconductor material, which is capable of simultaneously having several increased electrical properties (e.g., high-charge carrier mobility, a high on/off current ratio (Iₒₙ/I_{off} ratio) and low off-state leakage current) by introducing CNTs having increased semiconductivity into the organic semiconductor material manufactured at lower production costs via more feasible application of a wet process at room temperature and a more practical manufacturing process, an organic semiconductor thin film using the same and an organic semiconductor device including the organic semiconductor thin film.

2. Description of the Related Art

Flat panel display devices (e.g., liquid crystal displays and organic electroluminescent displays) may include a number of thin film transistors (TFTs) for driving the devices.

Organic thin-film transistors (OTFTs) may include a substrate, a gate electrode, an insulating layer, source/drain electrodes and/or a channel layer. Organic thin-film transistors may be classified as bottom-contact (BC) OTFTs wherein a channel layer may be formed on source and drain electrodes or top-contact (TC) OTFTs wherein metal electrodes may be formed on a channel layer by mask deposition.

Inorganic semiconductor materials (e.g., silicon (Si)) have been commonly used for channel layers of organic thin-film transistors (OTFTs). As demand for the manufacture of large-area flexible displays at reduced costs increases, organic semiconductor materials may be used as materials for channel layers opposed to more costly inorganic semiconductor materials that may require high-temperature vacuum processes.

Studies on organic semiconductor materials used for channel layers of organic thin-film transistors (OTFTs) have been undertaken and the characteristics of the transistors have been reported.

Of the organic semiconductor materials, research focuses on low-molecular weight materials and oligomers (e.g., melocyanines, phthalocyanines, perylenes, pentacenes, soluble pentacenes, oligothiophenes and the like). Organic semiconductor materials having a lower molecular weight (e.g., pentacenes) may have a relatively higher charge carrier mobility of 1.0 to 5.0 cm²/Vs and a relatively higher on/off current ratio (Iₒₙ/I_{off} ratio). The organic semiconductor materials having a lower molecular weight may necessitate the use of costly vacuum deposition equipment when forming thin films.

Of the polymer organic semiconductor materials, the conventional art acknowledges the use of F₈T₂, regioregular poly(3-hexylthiophene) (P₃HT). The polymer organic semiconductor materials may be inexpensive materials but may be difficult to apply to semiconductor devices due to lower charge carrier mobility of 0.1 cm²/Vs.

The conventional art also discloses an organic semiconductor material in which carbon nanotubes may be dispersed in a conjugated polymer. A weight fraction of carbon nanotubes may be less than about 3% relative to the conjugated polymer and an organic semiconductor device utilizing the same. The conventional art also acknowledges the problems associated with lower charge carrier mobility and higher production costs which may present obstacles when applying conventional organic semiconductor materials by a wet process using a mixture of the conjugated polymer and the carbon nanotubes. According to the above-mentioned technique, the off-current may increase, in conjunction with the charge carrier mobility. As such, the on-off current ratio may decrease compared to the organic semiconductor material and semiconductor device having no carbon nanotubes.

### SUMMARY OF THE INVENTION

Example embodiments of the present invention relate to an organic semiconductor material using carbon nanotubes (CNTs) having increased semiconductivity, an organic semiconductor thin film using the same and an organic semiconductor device employing the thin film. Other example embodiments of the present invention relate to an organic semiconductor material, which is capable of simultaneously having several increased electrical properties (e.g., high-charge carrier mobility, a high on/off current ratio (Iₒₙ/I_{off} ratio) and low off-state leakage current) by introducing CNTs having increased semiconductivity into the organic semiconductor material, an organic semiconductor thin film using the same and an organic semiconductor device including the organic semiconductor thin film.

Example embodiments of the present invention relate to a novel organic semiconductor material that may be spin-cast at room temperature and simultaneously exhibit higher charge carrier mobility, a higher on-off current ratio (Iₒₙ/I_{off} ratio) and a lower off-state leakage current.

Other example embodiments of the present invention provide a high-performance organic semiconductor thin film that may be fabricated at lower production costs and/or exhibit increased electrical properties by using the above-mentioned organic semiconductor material and an organic semiconductor device using the same.

In accordance with example embodiments of the present invention, a novel organic semiconductor material, including an organic semiconductor material and carbon nanotubes having a semiconductivity ratio of 2/3 or higher, is provided.

In accordance with other example embodiments of the present invention, there is provided an organic semiconductor thin film, which is formed using the above organic semiconductor material.

In accordance with further example embodiments of the present invention, there is provided an organic semiconductor device including the above organic semiconductor thin film as a channel layer.

Other example embodiments of the present invention are directed to an organic semiconductor device wherein the device is an organic thin-film transistor.

### BRIEF DESCRIPTION OF THE DRAWINGS

Example embodiments of the present invention will be more clearly understood from the following detailed description taken in conjunction with the accompanying drawings. FIGS. 1-7 represent non-limiting, example embodiments of the present invention as described herein.

FIG. 1 is a graph showing the results of Raman analysis at a wavelength of 514 nm for fluorinated CNTs obtained in Preparative Example 1 according to example embodiments of the present invention;

FIG. 2 is a graph showing the results of Raman analysis at a wavelength of 785 nm for fluorinated CNTs obtained in Preparative Example 1 according to example embodiments of the present invention;

FIG. 3 is a graph showing the results of Raman analysis at a wavelength of 633 nm for fluorinated CNTs obtained in Preparative Example 1 according to example embodiments of the present invention;

FIGS. 4a-c are graphs showing the results of photon energy analysis for fluorinated CNTs obtained in Preparative Example 1 and conventional CNTs, and the results of calculation of semiconductivity;

FIG. 5 is diagram illustrating an SEM of fluorinated CNTs obtained in Preparative Example 1 according to example embodiments of the present invention;

FIG. 6 is diagram illustrating an SEM of conventional CNTs used in according to example embodiments of the present invention; and

FIG. 7 is a graph showing current transfer curve of organic thin-film transistors (OTFTs), obtained in Example 1 and Comparative Examples 1 and 2, respectively.

### DESCRIPTION OF EXAMPLE EMBODIMENTS

Various example embodiments of the present invention will now be described more fully with reference to the accompanying drawings in which some example embodiments of the invention are shown. In the drawings, the thicknesses of layers and regions may be exaggerated for clarity.

Detailed illustrative embodiments of the present invention are disclosed herein. However, specific structural and functional details disclosed herein are merely representative for purposes of describing example embodiments of the present invention. This invention may, however, may be embodied in many alternate forms and should not be construed as limited to only example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the invention to the particular forms disclosed, but on the contrary, example embodiments of the invention are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the scope of example embodiments of the present invention.

Spatially relative terms, such as “beneath,” “below,” “lower,” “above,” “upper” and the like, may be used herein for ease of description to describe one element or a relationship between a feature and another element or feature as illustrated in the figures. It will be understood that the spatially relative terms are intended to encompass different orientations of the device in use or operation in addition to the orientation depicted in the Figures. For example, if the device in the figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

Example embodiments of the present invention are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments of the invention should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope of the present invention.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments of the present invention belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In order to more specifically describe example embodiments of the present invention, various aspects of the present invention will be described in detail with reference to the attached drawings. However, the present invention is not limited to example embodiments described.

Example embodiments of the present invention relate to an organic semiconductor material using carbon nanotubes (CNTs) having increased semiconductivity, an organic semiconductor thin film using the same and an organic semiconductor device employing the thin film. Other example embodiments of the present invention relate to an organic semiconductor material, which is capable of simultaneously having several increased electrical properties (e.g., high-charge carrier mobility, a high on/off current ratio (Iₒₙ/I_{off} ratio) and low off-state leakage current) by introducing CNTs having increased semiconductivity into the organic semiconductor material manufactured at lower production costs by a wet process, an organic semiconductor thin film using the same and an organic semiconductor device including the organic semiconductor thin film.

Example embodiments of the present invention provide a novel organic semiconductor material including an organic semiconductor material and carbon nanotubes having a semiconductivity ratio of 2/3 or higher.

The carbon nanotubes may exhibit semiconductive or metallic properties depending upon the dried forms thereof. The carbon nanotubes may have mixed properties of semiconductive and metallic properties in about a 2:1 ratio. When the carbon nanotubes having semiconductive and metallic properties are used as an organic semiconductor material by mixing and dispersing the carbon nanotubes in conventional organic semiconductor materials, a wet process (e.g., spin casting) may be performed. The wet process may be inexpensive, simplified and performed at room temperature. When the carbon nanotubes having semiconductive and metallic properties are used as an organic semiconductor material by mixing and dispersing the carbon nanotubes in conventional organic semiconductor materials, electrical properties (e.g., increased charge carrier mobility) may increase. An off-current property may also increase, which may result in a decrease in the on-off current ratio. It may be difficult to apply the carbon nanotubes to semiconductor devices when the on-off current ratio decreases. By using carbon nanotubes having increased semiconductivity compared to conventional carbon nanotubes, the above-mentioned problems may be avoided (or the effects thereof reduced). The above-mentioned problems may also be avoided (or the effects thereof reduced) by utilizing the semiconductivity-increased carbon nanotubes in any semiconductor material such that the semiconductor material exhibits higher semiconductivity. Example embodiments of the present invention provide an organic semiconductor material which is obtained by mixing a known organic semiconductor material with carbon nanotubes. A semiconductivity ratio of the organic semiconductor material having the carbon nanotubes may increase to approximately ⅔ or higher.

The semiconductivity of the carbon nanotubes may be in a range of about 75% to 100%. The semiconductivity of the carbon nanotubes may be in a range of about 82 to 95%.

The carbon nanotubes may be mixed in an amount of about 0.001 to 5 parts-by-weight relative to 100 parts-by-weight of the organic semiconductor material. When the amount of the carbon nanotubes to be mixed exceeds about 5 parts-by-weight, desirable dispersion effects may be difficult to obtain due to the occurrence of aggregation between carbon nanotube particles. It may also be difficult to achieve other desired effects (e.g., a decrease of off-current and/or an increase of an on-off current ratio) due to increased metallic properties.

The carbon nanotubes with increased semiconductivity may be prepared by a variety of methods well-known in the art. The carbon nanotubes with increased semiconductivity may be prepared (or obtained) using a method of separating semiconductive carbon nanotubes or removing metallic properties from the conventional carbon nanotubes. These methods may be prepared without limitation.

The method of separating semiconductive carbon nanotubes may include, but is not limited to, dielectrophoresis and electroless plating, as acknowledged by the conventional art.

The method of removing metallic properties may include, but is not limited to, charge transfer of bromine (Br) or fluorine (F) and diazonium functionalization of metallic carbon nanotubes.

The carbon nanotubes may be prepared (or obtained) using a method of removing metallic properties from the conventional carbon nanotubes by charge transfer of fluorine (F).

Examples of suitable carbon nanotubes that can be used include, but are not limited to, single-walled carbon nanotubes (SWNTs), double-walled carbon nanotubes (DWNTs), multi-walled carbon nanotubes (MWNTs) and bundles of carbon nanotubes, and combinations thereof. An increase in mobility may be easier to obtain due to a higher density per volume (e.g., surface area), when using single-walled carbon nanotubes.

The carbon nanotubes may have a tube diameter of 0.9 nm or greater. Carbon nanotubes having a tube diameter of 0.9 nm or less, may not exhibit increased metallic properties compared carbon nanotubes having a tube diameter of 0.9 nm or greater. The carbon nanotubes may have a tube diameter in a range of 0.9 nm to 1.1 nm. In the range of 0.9 nm to 1.1. nm, desired semiconductive properties may appear.

The organic semiconductor material may be formed of any organic semiconductor material well-known in the art. Depending upon the desired applications, the organic semiconductor material may be one selected from the group consisting of low-molecular weight organic semiconductor materials and high-molecular weight organic semiconductor materials. Examples of the organic semiconductor materials that can be used in the present invention include, but are not limited to, pentacenes, oligothiophenes, polythiophenes, P₃HT, F₈T₂, melocyanines, phthalocyanines, perylenes and derivatives thereof. These materials may be used alone or in any combination thereof.

Other example embodiments of the present invention provide an organic semiconductor thin film which is formed using the organic semiconductor material as described above.

The organic semiconductor thin film may be formed by dissolving and dispersing the organic semiconductor material in an organic solvent. The resulting dispersion may be coated on a substrate.

The organic solvent may include conventional organic solvents, without any particular limitation. Examples of organic solvents that may be used include, but are not limited to alcohols (e.g., methyl alcohol, ethyl alcohol, n-propyl alcohol, isopropyl alcohol, n-butyl alcohol, sec-butyl alcohol, tert-butyl alcohol, isobutyl alcohol and diacetone alcohol), ketones (e.g., acetone, methyl ethyl ketone and methyl isobutyl ketone), glycols (e.g., ethylene glycol, diethylene glycol, triethylene glycol, propylene glycol, butylene glycol, hexylene glycol, 1,3-propanediol, 1,4-butanediol, 1,2,4-butanetriol, 1,5-pentanediol, 1,2-hexanediol and 1,6-hexanediol), glycol ethers (e.g., ethylene glycol monomethyl ether and triethylene glycol monoethyl ether), glycol ether acetates (e.g., propylene glycol monomethyl ether acetate (PGMEA)), acetates (e.g., ethyl acetate, butoxyethoxy ethyl acetate, butyl carbitol acetate (BCA) and dihydroterpineol acetate (DHTA)), terpineols, trimethyl pentanediol monoisobutyrate (TEXANOL), dichloroethene (DCE), chlorobenzene and N-methyl-2-pyrrolidone (NMP). These organic solvents may be used alone or in any combination.

In order to increase dispersibility and solubility of the organic semiconductor material, the organic semiconductor material forming the thin film may be added at a concentration of about 0.1 to 20% by weight relative to the organic solvent.

Dissolving and dispersion processes of the organic semiconductor material may be performed at a temperature of 30° C. to 60° C. for about 30 min to 5 hours. When the temperature is less than 30° C. during the dissolving and dispersion of the organic semiconductor material, solidification of the organic semiconductor material may occur over time, failing to sufficiently dissolve the organic semiconductor material. Dissolving and dispersion processes performed at a temperature of greater than 60° C. may have adverse effects on semiconductor properties of the organic semiconductor materials. The dissolving and dispersion processes may be performed at a temperature of 40° C. to 50° C. for about 2 to 4 hours, after coating.

Acid or base may be added or ultrasonication may be performed in order to increase solubility of the semiconductor material and stabilize a dispersion state of carbon nanotubes. The acid or base may be added such that the acid or basic treatment is not detrimental to the desired example embodiments of the present invention. If necessary and depending upon the intended application, one or more other additives may be further added including an organic binder, a photosensitive monomer, a photoinitiator, a viscosity-adjusting agent, a storage stabilizer and/or a wetting agent.

The organic semiconductor thin-film may be formed on any substrate appreciated in the art in accordance with example embodiments of the present invention. Examples of suitable substrates that may be used include glass substrates, silicon wafers, ITO glass, quartz, silica-coated substrates, alumina-coated substrates and plastic substrates.

Coating may be performed using conventional room-temperature wet processes without any particular limitation. Coating may be performed by spin casting, dip coating, roll coating, screen coating, spray coating, screen printing, ink jetting and/or drop casting. For convenience and more uniform coating, spin casting may be performed. When spin casting, the spin speed may be adjusted within the range of about 100 rpm to 10,000 rpm.

The organic semiconductor thin-film may have a thickness of about 300 Å to 2,000 Å.

The organic semiconductor thin-film may be formed using the novel organic semiconductor material to which carbon nanotubes having increased semiconductivity may be incorporated therein. The organic semiconductor thin-film formed using the novel organic semiconductor material may enable application of a simplified room-temperature wet process and exhibit increased electrical properties (e.g., simultaneous fulfillment of high-charge carrier mobility, a higher on/off current ratio and lower off-state leakage current. The organic semiconductor thin-film may be more effectively applied to a variety of organic semiconductor devices.

In other example embodiments of the present invention an organic semiconductor device including the above organic semiconductor thin film as a channel layer is provided. Examples of the organic semiconductor device include, but are not limited to, organic thin-film transistors, organic electroluminescent devices, solar cells and polymer memories.

The organic semiconductor thin film may be applied to the above-mentioned devices using conventional processes well-known in the related art.

Of the above-mentioned organic semiconductor devices, example embodiments may be directed to an organic thin-film transistor. The organic thin-film transistor may include a substrate, a gate electrode, an organic insulating layer, a channel layer and/or source/drain electrodes. The organic thin-film transistor may include an organic semiconductor thin film as the channel layer. The organic semiconductor thin film may be formed from the organic semiconductor material according to example embodiments of the present invention.

The organic thin-film transistor may have a bottom-contact, top-contact or top-gate structure. The bottom-contact, top-contact or top-gate structure may be similar to structures well-known in the art. The bottom-contact, top-contact or top-gate structure may be embodied in many different structures with modifications in accordance with example embodiments of the present invention.

Any substrate well-known in the art may be used as a substrate for the organic thin-film transistor. The substrate may be formed of glass, silica and/or plastic (e.g., polyethylenenaphthalate (PEN), polyethyleneterephthalate (PET), polycarbonate, polyvinylalcohol, polyacrylate, polyimide, polynorbonene, polyethersulfone (PES) and the like).

The gate electrode and source/drain electrodes may be formed metals appreciated in the art. Examples metals include, but are not limited to, gold (Au), silver (Ag), aluminum (Al), nickel (Ni), indium tin oxide (ITO) and molybdenum/tungsten (Mo/W). The gate electrode and source/drain electrodes may have a thickness of about 500 Å and 2,000 Å, respectively.

The insulating layer may be formed of any high-dielectric constant insulator known in the art. Examples of suitable insulators include, but are not limited to ferroelectric insulators selected from the group consisting of Ba_{0.33}Sr_{0.66}TiO₃ (BST), Al₂^{O}₃, Ta₂O₅, La₂O₅, Y₂O₃ and TiO₂; inorganic insulators selected from the group consisting of PbZr_{0.33}Ti_{0.66}O₃ (PZT), Bi₄Ti₃O₁₂, BaMgF₄, SrBi₂(TaNb)₂O₉, Ba(ZrTi)O₃ (BZT), BaTiO₃, SrTiO₃, Bi₄Ti₃O₁₂, SiO₂, SiNₓ and A10N; and organic insulators selected from the group consisting of polyimides, benzocyclobutenes (BCBs), parylenes, polyacrylates, polyvinylalcohols and polyvinylphenols. The insulating layer may have a thickness in the range from approximately 3,000 Å to 1 μm.

Example embodiments of the present invention will be described in more detail with reference to the following examples. These examples are provided only for illustrating example embodiments and should not be construed as limiting the scope and spirit of the present invention.

### Preparation of Carbon Nanotubes Having Increased Semiconductivity

### Preparative Example 1

Single-walled carbon nanotubes (SWNTs) were placed in a chamber and subjected to heat treatment at 200° C. under 10⁻³ torr vacuum for 1 hour in order to remove air from the chamber and remove moisture in the carbon nanotubes. The chamber temperature was lowered to room temperature. Fluorine (F₂) gas was allowed to flow into the chamber at 0.1 bar working pressure for about 10 min, preparing carbon nanotubes having increased semiconductivity.

Analysis of Carbon Nanotubes having Increased Semiconductivity

### Raman Analysis

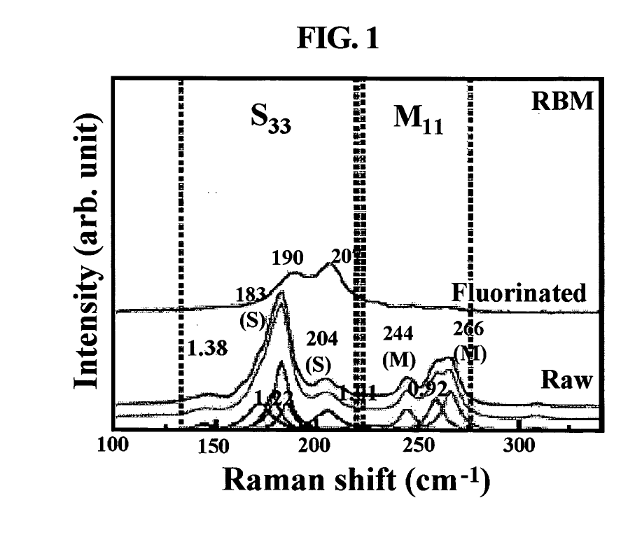

In order to determine whether carbon nanotubes having semiconductivity increased by fluorination as in Preparative Example 1 were prepared as desired, single-wall carbon nanotubes (SWCNTs) was analyzed by Raman spectra in RBM mode at a wavelength of 514 nm. Common SWCNTs, which were not fluorinated, were also analyzed by Raman analysis as a standard. The results obtained are shown in FIG. 1.

Referring to FIG. 1, in contrast to the common SWCNTs (labeled ‘Raw’) used as the standard, the fluorinated SWCNTs according to example embodiments of the present invention exhibited peaks only in Region S₃₃, which correspond to semiconductor characteristics, but did not show any peaks in Region M₁₁, which corresponds to metallic characteristics. As such, the semiconductivity of nanotubes was increased due to removal of metallic characteristics of CNTs having a diameter of 0.9 nm to 1.1 nm by fluorination.

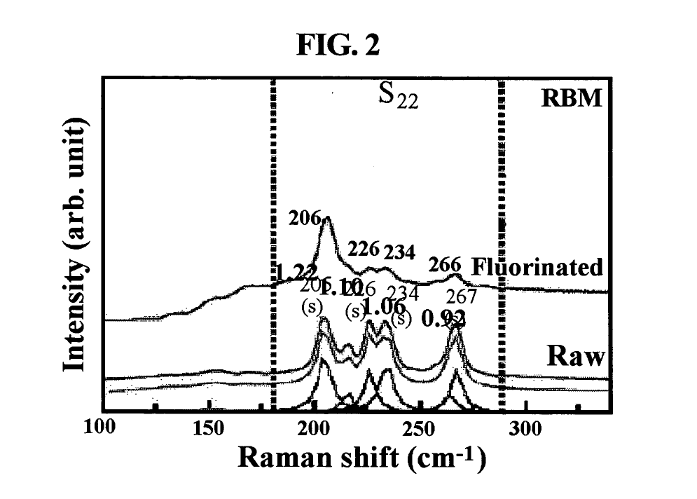

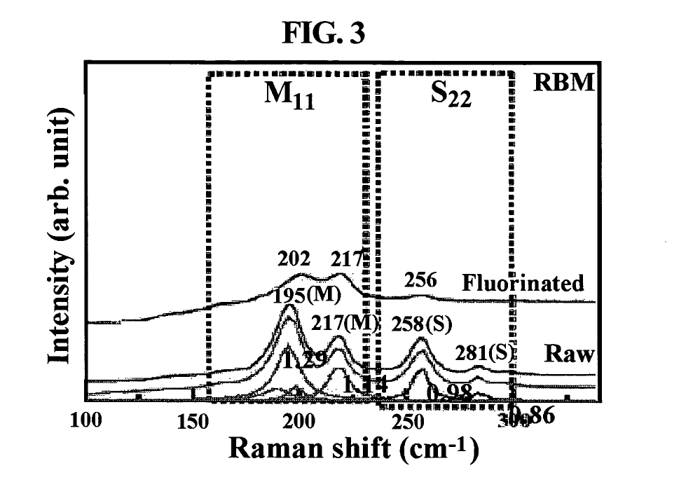

FIG. 2 is a graph showing the results of Raman analysis at a wavelength of 785 nm for fluorinated CNTs obtained in Preparative Example 1 according to example embodiments of the present invention. FIG. 3 is a graph showing the results of Raman analysis at a wavelength of 633 nm for fluorinated CNTs obtained in Preparative Example 1 according to example embodiments of the present invention

Referring to FIGS. 2 and 3, the fluorinated carbon nanotubes according to example embodiments of the present invention exhibited peaks only in Region S₂₂, which corresponds to semiconductor characteristics, at a wavelength of 785 nm (similar to the above results at 514 nm). The Region M₁₁, which corresponds to metallic characteristics of CNTs having a diameter of more than 1.1 nm at a wavelength of 633 nm, still remained.

### Photon Energy Analysis and Semiconductivity Calculation

The absorbance of the fluorinated CNTs and common CNTs was measured using UV-Vis spectroscopy and analyzed in terms of absorbance per photon energy in order to further analyze the semiconductivity of the fluorinated carbon nanotubes (CNTs) obtained in Preparative Example 1. Based on the analysis results obtained, the percentage of semiconductivity of CNTs was calculated from Equation 1:

$$\frac{{S}_{22}}{{S}_{22} + {M}_{11}} \qquad Equation 1$$

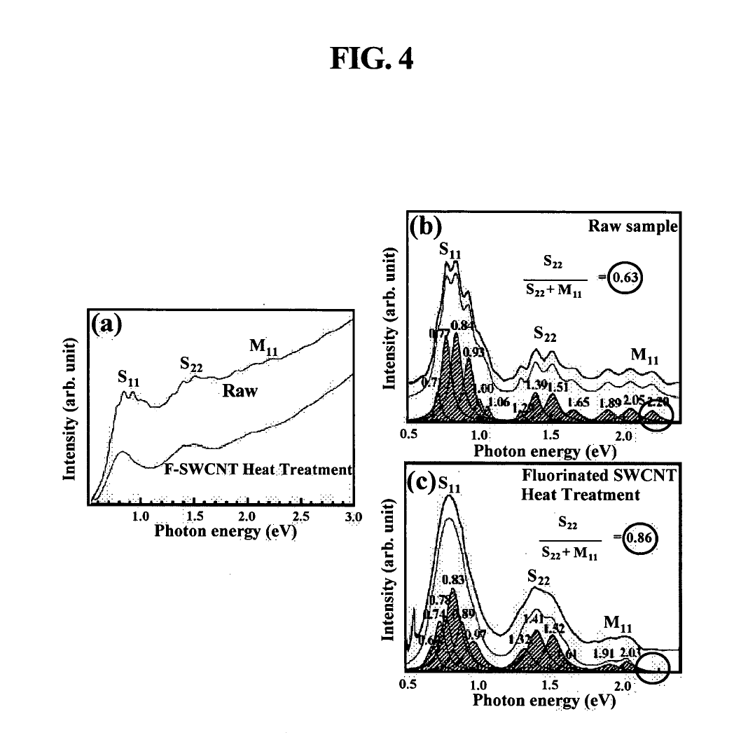

The results obtained are shown in FIGS. 4a-c. FIG. 4a is a graph showing the results of photon energy analysis for fluorinated CNTs obtained in Preparative Example 1 (labeled as ‘F-SWCNT Heat Treatment’) and conventional CNTs (labeled as ‘Raw’). Referring to the results of FIGS. 4b and 4c, the conventional CNTs exhibit a semiconductivity of 63% (as shown in FIG. 4b), whereas the fluorinated CNTs according to example embodiments of the present invention exhibited semiconductivity of 86% (as shown in FIG. 4c). As such, the treatment of CNTs with fluorine resulted in a significantly increased proportion of semiconductivity (e.g., a semiconductivity ratio of greater than 2/3 ratio).

### SEMs of Carbon Nanotubes

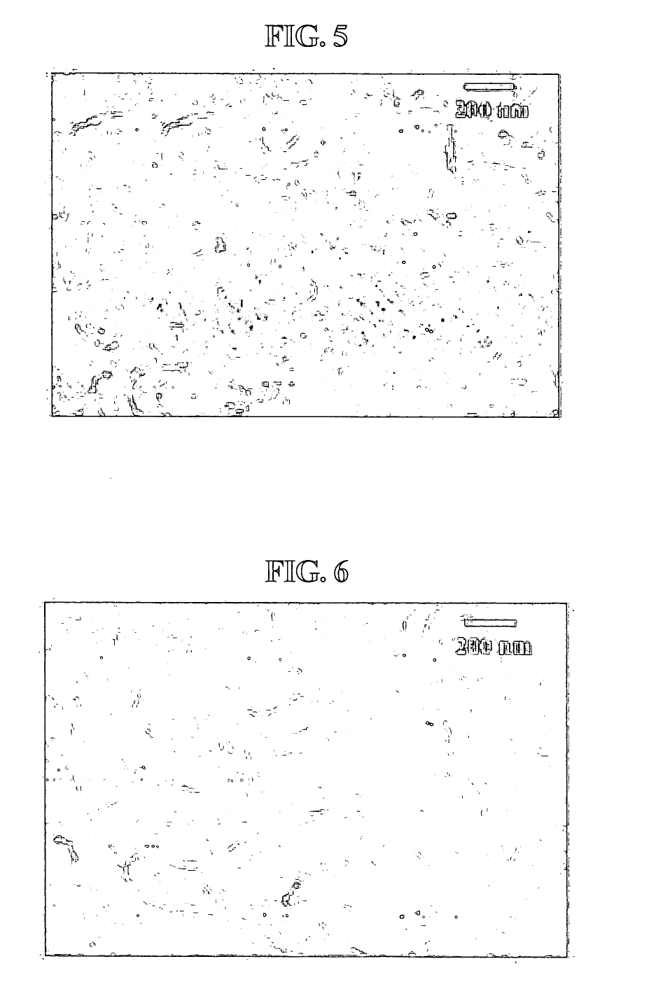

FIG. 5 is diagram illustrating an SEM of fluorinated CNTs obtained in Preparative Example 1 according to example embodiments of the present invention.

FIG. 6 is diagram illustrating an SEM of conventional CNTs used in according to example embodiments of the present invention.

### Preparation of Organic Thin-Film Transistor

### Example 1

A polythiophene polymer, having a molecular weight of 10,000 to 50,000, was dissolved to a 1 wt % concentration in chlorobenzene at 45° C. The fluorinated carbon nanotubes (CNTs) obtained in Preparative Example 1 were added to the resulting solution, in an amount of 1.5 parts-by-weight relative to the polythiophene polymer. The solution was dispersed for 3 hours by ultrasonication, obtaining a solution of an organic semiconductor material according to example embodiments of the present invention. A molybdenum/tungsten (Mo/W) alloy was deposited having a thickness of 1000 Å on a clean glass substrate by sputtering, forming a gate electrode. SiO₂ was deposited having a thickness of 5000 Å thereon by chemical vapor deposition (CVD), forming a gate insulating layer. By spin casting at 2,000 rpm, the organic semiconductor material solution was then coated to a thickness of 1,000 Å on the gate insulating layer, followed by baking at 100° C. under argon atmosphere for 10 min, forming a channel layer. Indium tin oxide (ITO) was deposited having a thickness of 1200 Å on the baked gate insulating layer by sputtering, forming source/drain electrodes, forming an organic thin-film transistor having a top-contact structure.

### Comparative Example 1

An organic thin-film transistor was fabricated in the same manner as in Example 1 except that a polythiophene polymer alone was used in preparation of an organic semiconductor material solution.

### Comparative Example 2

An organic thin-film transistor was fabricated in the same manner as in Example 1 except that common single-walled carbon nanotubes (SWNTs) were used in preparation of an organic semiconductor material solution, instead of the fluorinated carbon nanotubes obtained in Preparative Example 1.

### Characterization of Organic Thin-film Transistor

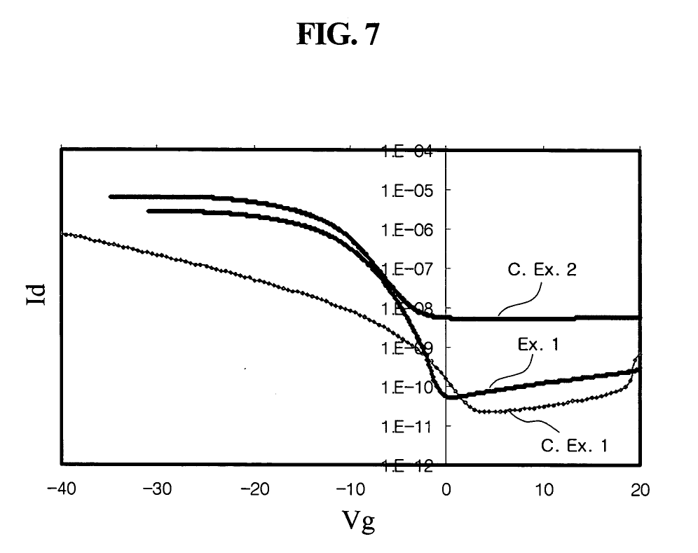

In order to evaluate the electrical properties of the organic thin-film transistors fabricated in Example 1 and Comparative Examples 1 and 2, the current transfer characteristics of the transistors were measured using a semiconductor analyzer (4200-SCS, KEITHLEY). The results obtained are shown in FIG. 7.

Referring to FIG. 7, compared to the organic thin-film transistor of Comparative Example 1, the organic thin-film transistor of Comparative Example 2 exhibited increases in on-state current and off-state current, resulting in deterioration of the Iₒₙ/I_{off} ratio. In contrast, the organic thin-film transistor according to example embodiments of the present invention, which was fabricated in Example 1, exhibited an increase in on-state current compared to Comparative Example 1 and a decrease in off-state current compared to Comparative Example 2, confirming simultaneous improvement in charge carrier mobility and Iₒₙ/I_{off} ratio.

FIG. 7 is a graph showing current transfer curve of organic thin-film transistors (OTFTs), obtained in Example 1 and Comparative Examples 1 and 2, respectively.

As shown in the current transfer curve of FIG. 7, the charge carrier mobility and Iₒₙ/I_{off} ratio were measured. The results obtained are shown in Table 1 below.

### Charge Carrier Mobility

Using the above-mentioned current transfer curve, the charge carrier mobility was calculated by plotting a graph using Equations 2. A-2D for the saturation region wherein (I_{SD})^{1/2} and V_{G} are parameters. The charge carrier mobility was calculated from the slope of graph.

$$\begin{matrix}{I}_{S D} = \frac{W {C}_{0}}{2 L} {μ ( {V}_{G} - {V}_{T} )}^{2} & Equation 2 A \\ \sqrt{{I}_{S D}} = \sqrt{\frac{μ {C}_{0} W}{2 L}} ( {V}_{G} - {V}_{T} ) & Equation 2 B \\ slope = \sqrt{\frac{μ {C}_{0} W}{2 L}} & Equation 2 C \\ {μ}_{FET} = {( slope )}^{2} \frac{2 L}{{C}_{0} W} & Equation 2 D\end{matrix}$$

wherein I_{SD} is the source-drain current, μ or μ_{FET} is the charge carrier mobility, C₀ is the capacitance of oxide film, W is the channel width, L is the channel length, V_{G} is the gate voltage and V_{T} is the threshold voltage

### Iₒₙ/I_{off} Ratio

The Iₒₙ/I_{off} ratio was determined from a ratio of a maximum current in the on-state to a minimum current in the off-state. The Iₒₙ/I_{off} ratio is represented by Equation 3:

$$\frac{{I}_{on}}{{I}_{off}} = ( \frac{μ}{σ} ) \frac{{C}_{0}^{2}}{q {N}_{A} {t}^{2}} {V}_{D}^{2} \qquad Equation 3$$

wherein Iₒₙ is the maximum current, I_{off} is the off-state leakage current, μ is the charge carrier mobility, σ is the conductivity of thin film, q is the electric charge, N_{A} is the electric charge density, t is the thickness of semiconductor film, C₀ is the capacitance of oxide film and V_{D} is the drain voltage.

The off-state leakage current (I_{off}), which is a current flowing in the off-state, was calculated as the minimum current in the off-state.

TABLE 1

| | Charge | | | |
|---|---|---|---|---|
| | carrier | | | |
| | mobility | On/Off | On | Off |
| Comp. Ex. 1 | 0.075 | 2.28E+04 | 5.69E−07 | 2.50E−11 |
| Comp. Ex. 2 | 1.13 | 1.51E+03 | 6.32E−06 | 4.24E−09 |
| Ex. 1 | 0.47 | 6.12+04 | 3.47E−06 | 5.67E−11 |

As shown Table 1, the organic thin-film transistor, which was fabricated using the organic semiconductor material including carbon nanotubes having increased semiconductivity incorporated therein according to example embodiments of the present invention, exhibited about 6-fold higher charge carrier mobility and about 3-fold higher On/Off ratio compared to the organic thin-film transistor of Comparative Example 1. The organic thin-film transistor according to example embodiments of the present invention may exhibit about 4-fold higher On/Off ratio compared to the organic thin-film transistor of Comparative Example 2. The organic thin-film transistor according to example embodiments of the present invention may have increase electrical properties in terms of charge carrier mobility, On/Off ratio and off-state leakage current.

As apparent from the above description, the organic semiconductor material according to example embodiments of the present invention is a novel type of an organic semiconductor material in which a desired amount of semiconductivity-increased carbon nanotubes were incorporated into a conventional organic semiconductor material. By using the organic semiconductor material according to example embodiments of the present invention as a thin film, it may be easier to perform a room-temperature wet process (e.g., spin casting) and to provide an organic semiconductor device having increase On-Off ratio and off-state leakage current.

The foregoing is illustrative of example embodiments of the present invention and is not to be construed as limiting thereof. Although a few example embodiments of the present invention have been described, those skilled in the art will readily appreciate that many modifications are possible in example embodiments without materially departing from the novel teachings and advantages of the present invention. Accordingly, all such modifications are intended to be included within the scope of this invention as defined in the claims. In the claims, means-plus-function clauses are intended to cover the structures described herein as performing the recited function, and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The present invention is defined by the following claims, with equivalents of the claims to be included therein.

1. An organic semiconductor material, comprising an organic semiconductor material and carbon nanotubes, wherein a ratio of semiconductive carbon nanotubes in the carbon nanotubes is 75% to 100% and the carbon nanotubes include brominated carbon nanotubes, fluorinated carbon nanotubes, or any combination thereof,
wherein the carbon nanotubes are 0.001 to 5 parts-by-weight relative to 100 parts-by-weight of the organic semiconductor material.

2-5. (canceled)

6. The semiconductor material according to claim 1, wherein the carbon nanotubes are selected from the group consisting of single-walled carbon nanotubes (SWNTs), double-walled carbon nanotubes (DWNTs), multi-walled carbon nanotubes (MWNTs), bundles of carbon nanotubes and any combination thereof.

7. The semiconductor material according to claim 1, wherein the carbon nanotubes have a tube diameter of 0.9 nm to 1.1 nm.

8. The semiconductor material according to claim 1, wherein the organic semiconductor material is selected from the group consisting of low-molecular weight organic semiconductor materials, high-molecular weight organic semiconductor materials and any combination thereof.

9. The semiconductor material according to claim 8, wherein the organic semiconductor material is selected from the group consisting of pentacenes, oligothiophenes, polythiophenes, P3HT, FgT2, melocyanines, phthalocyanines, perylenes, derivatives thereof and any combination thereof.

10. An organic semiconductor thin film formed using the organic semiconductor material according to claim 1.

11. The film according to claim 10, wherein the organic semiconductor thin film is formed by dissolving and dispersing the organic semiconductor material in an organic solvent to form a dispersion; and coating the dispersion on a substrate.

12. The film according to claim 11, wherein the organic solvent is at least one selected from the group consisting of
alcohols including methyl alcohol, ethyl alcohol, n-propyl alcohol, isopropyl alcohol, n-butyl alcohol, sec-butyl alcohol, tert-butyl alcohol, isobutyl alcohol and diacetone alcohol,
ketones including acetone, methyl ethyl ketone and methyl isobutyl ketone; glycols including ethylene glycol, diethylene glycol, triethylene glycol, propylene glycol, butylene glycol, hexylene glycol, 1,3-propanediol, 1,4-butanediol, 1,2,4-butanetriol, 1,5-pentanediol, 1,2 hexanediol and 1,6-hexanediol,
glycol ethers including ethylene glycol monomethyl ether and triethylene glycol monoethyl ether,
glycol ether acetates including propylene glycol monomethyl ether acetate (PGMEA);
acetates including ethyl acetate, butoxyethoxy ethyl acetate, butyl carbitol acetate (BCA) and dihydroterpineol acetate (DHTA),
terpineols, trimethyl pentanediol monoisobutyrate (TEXANOL), dichloroethene (DCE); chlorobenzene and N-methyl-2-pyrrolidone (NMP).

13. The film according to claim 11, wherein the dissolving and dispersion processes are performed at a temperature of 30° C. to 60° C. for 30 min to 5 hours.

14. The film according to claim 11, wherein the coating method is selected from the group consisting of spin casting, dip coating, roll coating, screen coating, spray coating, screen printing, ink jetting and drop casting.

15. An organic semiconductor device including the organic semiconductor thin film of claim 10.

16. The device according to claim 15, wherein the organic semiconductor device is an organic thin-film transistor, an organic electroluminescent device, a solar cell or polymer memory.

17. The device according to claim 15, wherein the organic semiconductor device is an organic thin-film transistor.
